(19) United States
(12) Patent Application Publication
(10) Pub. No.: US 2016/0314125 A1
(43) Pub. Date: Oct. 27, 2016

(54) Predictive Coding System and Method

(71) Applicant: George Witwer, Bluffton, IN (US)

(72) Inventor: George Witwer, Bluffton, IN (US)

(21) Appl. No.: 15/076,159

(22) Filed: Mar. 21, 2016

Related U.S. Application Data
(60) Provisional application No. 62/135,454, filed on Mar. 19, 2015.

(51) Int. Cl. G06F 17/30

(52) U.S. Cl. CPC G06F 17/3053; G06F 17/30011

(57) ABSTRACT

The present invention relates to a system and method for retrieval of information from computer readable documents and files using an improved process for data extraction and analysis.

### CROSS-REFERENCE TO RELATED APPLICATIONS

Provisional Patent—62/135,454 Filed—Mar. 19, 2015

The benefit of U.S. Provisional Patent Application No. 62/135,454 (filed Mar. 19, 2015) is claimed, and that provisional application is hereby incorporated by reference.

### STATEMENT REGARDING FEDERAL SPONSORED RESEARCH OR DEV.

Not applicable.

### FIELD OF THE DISCLOSURE

The present disclosure relates to systems and methods for examining computer readable documents and files and extracting information from same for further analysis and determination using a defined system and/or method.

### BACKGROUND OF THE INVENTION

There are several approaches to information retrieval from computer readable documents and files. The most basic method of searching and analyzing these documents was either by keyword/Boolean searching or manual review. However, there are inherent limitations in both, but most notably with manual review is the time and the cost associated with this review. As for Boolean searching it fails to capture the semantic meaning of the documents it seeks to find, as well as the conceptual insight of the document collection to be searched. Information retrieval using Boolean search is particularly difficult because the user can not precisely know what to search for due to a lack of understanding of what knowledge can be retrieved.

More modern approaches include vector-space method, conceptual search, taxonomy, machine learning and statistical inference. A mathematical approach to concept retrieval is latent semantic indexing (LSI) aka latent semantic analysis.

LSI is a method of indexing and retrieving documents that uses a mathematical technique called singular value decomposition (SVD). SVD identifies patterns in the relationships between the terms and concepts contained in unstructured text collections. The fundamental logic of LSI is that words that are used in the same contexts tend to have similar (not exact) meanings. One of the key benefits of LSI is its ability to extract the conceptual content of a body of text by establishing associations between those terms that occur in similar contexts using queries. Queries, or concept searches, run against a set of documents that have undergone LSI indexing, will return results that are conceptually similar in meaning to the search criteria even if the results don't share a specific word or words with the search criteria. In this regard, it is far stronger than keyword matching.

Latent semantic indexing is an important improvement over basic document indexing process. In addition to recording which keywords a document contains, LSI also examines the document collection as a whole, to see which other documents contain some of those same words. LSI considers documents that have many words in common to be semantically close, and ones with few words in common to be semantically distant. This simple method correlates surprisingly well with how a human being, looking at content, might classify a document collection, but it does it with more consistency and faster than humans can perform the task.

When a search engine is pointed to an index created using LSI rules, it examines similarity values it has calculated for every content word, and returns the documents that it thinks best match the query request. Since two documents may not share a particular keyword, but may be deemed semantically close, LSI will show those document results as likely to be related. Where a plain keyword search will fail if there is no exact match, LSI will often return relevant documents that don't contain the keyword at all.

Two of the most problematic constraints of Boolean keyword queries are removed by LSI queries: 1) multiple words that have similar meanings (synonymy) and 2) words that have more than one meaning (polysemy). Synonymy often causes mismatches of author vocabulary in documents and the users of information retrieval systems. This often results in Boolean or keyword queries that return irrelevant results and while not returning potentially relevant information.

Further, LSI automatically adapts to new and changing terminology, and has been shown to be very tolerant of “noise”, which includes things such as misspelled words, typographical errors and unreadable characters. This is especially important for applications using text derived from Optical Character Recognition (OCR) and speech-to-text conversion which has incomplete text due to conversion issues. Additionally, text does not need to be in sentence form for LSI to be effective. It can work with lists, free-form notes, email, Web-based content, etc. As long as a collection of text contains multiple terms, LSI can be used to identify patterns in the relationships between the important terms and concepts contained in the text.

Thus, while LSI is an improvement, the current state of LSI uses only a single similarity measure. This is like using only one tool, such as a hammer, for every job in building a house. The present invention uses multiple similarity measures applied in LSI, each of which is independently adjustable, to create an infinite number of combinations of similarity measures. This flexibility is critical when dealing with different types of data and structure, as well as the varied goals for the search.

### BRIEF SUMMARY OF THE INVENTION

Latent Semantic Indexing (LSI) is a dimensionality reduction technique that projects documents into a semantic space to find conceptually similar documents. LSI uses a statistically derived index, instead of words from the input. Then it uses singular value decomposition (SVD) to estimate the structure of word usage. SVD takes a high dimensional, highly variable data set and reduces it to a lower dimensional space that exposes the substructure of the original data. SVD decomposes a document-term matrix into the product of three matrices.

A_{n×d}=U_{n×n}S_{n×d}V^{T}_{d×d}

U and V represent terms and documents, and S is the diagonal matrix containing singular values of A. By restricting the matrices to their first K rows (where K is much smaller than total number of terms), one can obtain a best square approximation of A. This new matrix is a reduced dimensional representation of the original document term matrix. Each dimension usually corresponds to a unique concept and the concepts are derived from the text collection as a whole, and not from the analysis of a single document.

The closer documents are in the reduced space the more similar they will be. Selecting ‘K’ can be difficult as using too small of a value for ‘K’ will cause loss of information and using a large value increases processing time and also the performance diminishes after a certain value K. Usually K values in the range of 100-200 works best in most cases. However, there is no fixed value of K that would work for all document collections. The present invention enables users to experiment with the value of ‘K’ using a control set.

Traditional LSI uses the average cosine similarity between the query vector and the document vectors in the seed set. This approach has a serious drawback that it will give a lower score to a document that is highly similar to one of the seed document but dissimilar to most of the seed documents. Also some applications may require ranking documents based on the similarity of their metadata in addition to the content-based the similarity regardless of the reliability of the metadata in your particular data collection. The system and method disclosed enhances LSI to make it work in both of these cases in it can provide a variety of similarity measures, but the preferred embodiment encompasses three different similarity metrics that contribute to the score of a document given an input seed document set. These similarity measures include:
1. Average Seed Similarity: This is the average cosine similarity of the input document with all seed documents
2. Best Seed Similarity: This is the similarity of the input document with the seed document closest to the given document in the reduced dimensional space. Put another way, this is the highest similarity of the document with any document in the seed set.
3. Metadata Similarity: This is the average metadata similarity of the document with any document in the seed set. Metadata similarity is based on the following standard fields due to their high reliability:
   a. Date
   b. Date Falloff
   c. Date within Days
   d. Email Address
   e. Title

The weights for each of these metrics are user configurable, i.e., “tuned”, to enhance results. The users have the ability, and it is recommended, that a control document set be used for this tuning.

Experiments were conducted to support the inventive nature of the disclosed system and method. This experiment was conducted on the learning task of TREC legal track—2010 data. A random subset of 20,000 documents was selected from the TREC data for this experiment. This task had 8 topics: 200 to 207. Each topic had a seed set of relevant and non-relevant documents. For these experiments, it was started with a small seed set of relevant documents and reported how many other relevant documents the approach retrieved using the seed set.

A traditional LSI method was used as a baseline and compared the disclosed system and method using F1-score as our evaluation metric. F1-score is the harmonic mean of precision and recall. In Information Retrieval, Precision is defined as the percentage of the retrieved documents that are relevant and Recall is defined as the percentage of relevant documents found. The disclosed system and method was ran, along with traditional LSI, for 20 iterations adding the top 10 ranked documents to the seed set after each iteration. FIG. 2 shows the F1-score comparison of the disclosed system and method with LSI on all topics. For each topic, a small control set was used of 5 relevant seed documents to determine the best set of weights for the three similarity metrics. Each F1-score in the graph is the average of 10 different runs with different initial seed set sizes. This shows that the disclosed system and method outperforms LSI on all topics.

The experimental results prove that the disclosed system and method performs better than traditional LSI on all topics of the learning task of the TREC legal 2010 track.

### BRIEF DESCRIPTION OF THE DRAWING(S)

FIG. 1—Flow Chart showing one embodiment of the system and method.

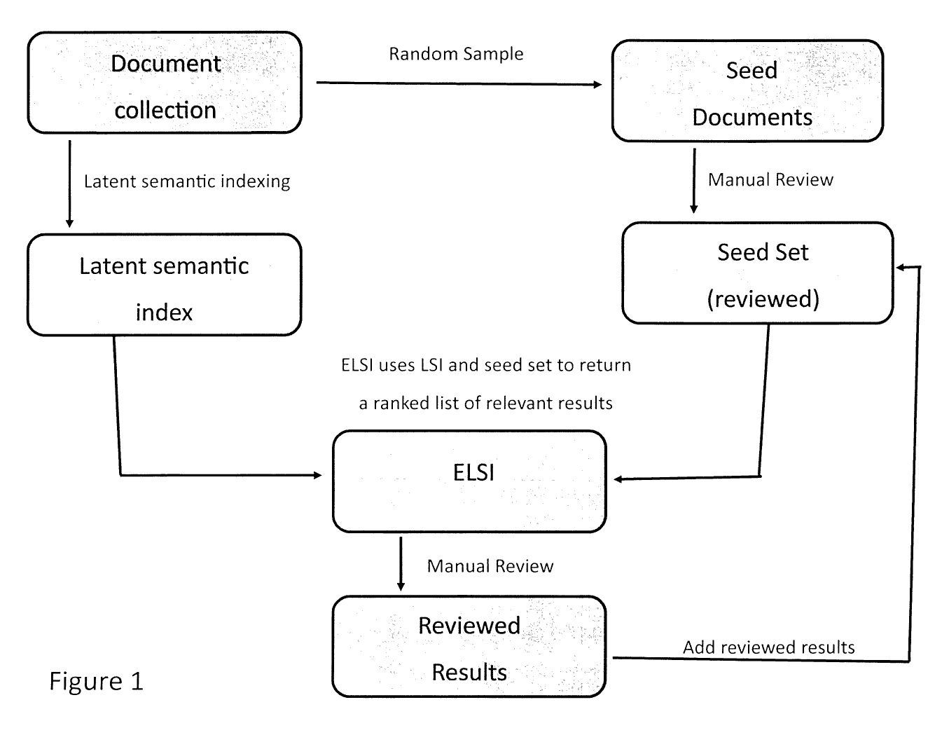

FIG. 2—Is a bar graph showing the comparison of the disclosed system versus previous methods.

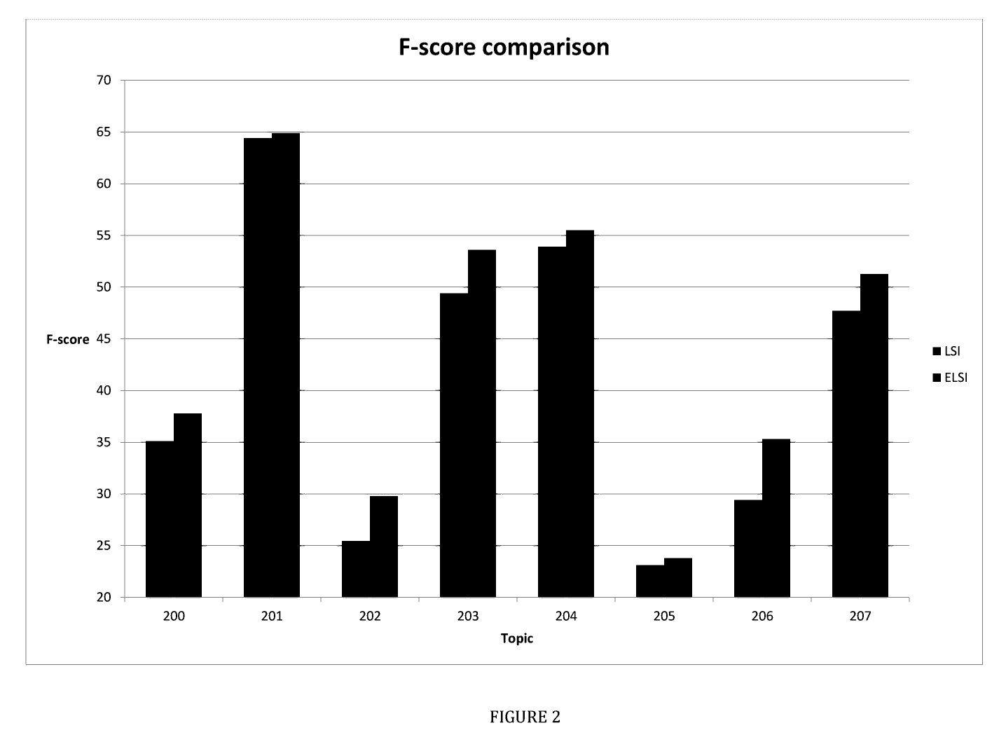

### DESCRIPTION

For the purpose of promoting an understanding of the principles of the present invention, reference will now be made to the embodiment illustrated in specific language contained herein. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

This invention involves using matrices based upon SVD application to a corpus of data. Doing this will allow us to see the underlying structure of the corpus. The resulting matrices are combined, with one matrix including the documents the corpus, the second being a compilation of the terms in the corpus and the last one being a matrix (diagonal) of the singular values of the results. These matrixes are then restricted to a number of rows less than the entire amount of documents. This restricted value is configurable and tunable based upon the corpus of documents, to achieve maximum results.

Once the above values are determined, further search result efficiency is obtained by using multiple similarity measures, which can be varied as to the amount of measures and what the measures include. In the present invention, such measures are three and include such as the average cosine similarity of the input document with all seed documents (“AS”); the similarity of the input document with the seed document closest to the given document in the reduced dimensional space (“BS”); and the average metadata similarity of the document with any document in the seed set (“MS”). The weights associated with each measure can be tweaked by the user, to fine-tune the results. This would normally be done through the use of a pre-defined control document set.

The user can adjust the similarity measures, including eliminating one or more, or adding one or more to the tool, as well as adjusting the weight associated with each measure, when applied to the search results. In this way, the user can maximize the search result effectiveness.

What is claimed is:

1. A computer-implemented method for processing a collection of data objects for use in information retrieval and data mining operations comprising the steps of:
a) generating a term document matrix to identify the occurrences of a number of unique terms within a collection of data objects;
b) local and global weighting functions are applied to the matrix;
c) a singular value decomposition is performed on the matrix to determine patterns and relationships between the terms and concepts contained in the data objects, thereby creating frequency vectors for term-concept, singular values and concept-document;
d) reduction of the matrix to a predetermined number of rows, which is an amount less than the total number of terms;
e) application of three similarity measures to the result, with the content of the measures and the weighting of each measure, determined and adjustable by the user.

2. The Method of claim 1 whereby the similarity measures are the average cosine similarity of the input document with all seed documents (“AS”); the similarity of the input document with the seed document closest to the given document in the reduced dimensional space (“BS”); and the average metadata similarity of the document with any document in the seed set (“MS”).

3. A computer-implemented method for processing a collection of data objects for use in information retrieval and data mining operations comprising the steps of:
a) generating a term document matrix to identify the occurrences of a number of unique terms within a collection of data objects;
b) local and global weighting functions are applied to the matrix;
c) a singular value decomposition is performed on the matrix to determine patterns and relationships between the terms and concepts contained in the data objects, thereby creating frequency vectors for term-concept, singular values and concept-document;
d) reduction of the matrix to a predetermined number of rows, which is an amount less than the total number of terms;
e) application of more than one similarity measure to the result, with the amount of measures, the content of the measures and the weighting of each measure, determined and adjustable by the user.
